(19) United States
(12) Patent Application Publication
(10) Pub. No.: US 2005/0114069 A1
(43) Pub. Date: May 26, 2005

(54) Die temperature control

(75) Inventor: Rabindra Bhola, Newmarket (CA)

Correspondence Address: BRINKS HOFER GILSON & LIONE, P.O. BOX 10395, CHICAGO, IL, 60610, US

(73) Assignee: Exco Technologies, Ltd.

(21) Appl. No.: 10/719,526

(22) Filed: Nov. 21, 2003

(51) Int. Cl. G06F 15/00

(52) U.S. Cl. 702/132

(57) ABSTRACT

To control the temperature of a die section of a die where the die section has a valved cooling line, an indication of instantaneous temperature of the die area is received and an average temperature over a pre-determined first time interval is determined from instantaneous temperature values for said first time interval. Based on the average temperature, a control parameter for the valve of the valved cooling line is determined. The valve is then controlled during a second time interval next subsequent to the first time interval based on the control parameter.

### BACKGROUND

This invention relates to die temperature control.

In a die casting machine, two or more die sections may be brought together to form a die cavity. Prior to bringing the sections together, the cavity areas are sprayed with a release agent. After the die sections are brought together, molten metal is introduced into the cavity. Once the metal in the cavity has frozen to form a die cast part, the die sections are taken apart and the die cast part removed. The die casting machine cycles through this operation to form a series of die cast parts. To form high quality die castings, the temperature of the die sections should remain within a certain temperature range, which is dependent upon the metal used for casting and the shape of the cavity. However, under the influence of the molten metal introduced into the cavity, the temperature of the die sections would rise above an acceptable temperature range. To avoid this result, the die sections are cooled by a coolant (e.g., water) which runs through valved cooling lines.

In order to maintain a die section within an acceptable temperature range, it is known to embed a temperature sensor in the die section and control a cooling valve based on instantaneous temperature readings from the temperature sensor.

In the vicinity of the cavity of the die, the temperature fluctuates continuously due to the heat from the melt at one part of each cycle and to the cooling effect of the spraying of the release agent at another part of each cycle. Known temperature control approaches do not provide tight temperature control in this environment. This risks reducing the quality of the die castings.

Therefore, there is a need for an improved manner of die temperature control.

### SUMMARY OF INVENTION

To control the temperature of a die section of a die where the die section has a valved cooling line, an indication of instantaneous temperature of the die area is received and an average temperature over a pre-determined first time interval is determined from instantaneous temperature values for said first time interval. Based on the average temperature, a control parameter for the valve of the valved cooling line is determined. The valve is then controlled during a second time interval next subsequent to the first time interval based on the control parameter.

The control parameter may be the proportion of the next interval during which the valve is to remain open or the degree to which the valve is opened during the next interval. The interval may be equal to the nominal time for one die cycle.

Accordingly the present invention provides a method of die temperature control, comprising: for a valved cooling line for a die area of a die: receiving an indication of instantaneous temperature of said die area cooled by said valved cooling line; determining an average temperature over a pre-determined first time interval from instantaneous temperature values for said first time interval; based on said average temperature, determining a control parameter for a valve of said valved cooling line; and controlling said valve during a second time interval next subsequent to said first time interval based on said control parameter.

A computer readable medium to effect the method, and a die casting machine implementing the method are also provided.

Other features and advantages of the invention will become apparent from a review of the following description, in conjunction with the drawings.

### DESCRIPTION OF THE DRAWINGS

In the figures which illustrate example embodiments of this invention,

FIG. 1 is a schematic illustration of a die casting machine with temperature control suitable for use with this invention,

FIG. 2 is a flow diagram showing an operation of the processor of the die machine of FIG. 1,

FIG. 3 is a time versus temperature graph illustrating temperature of a die section when controlled in the manner described in conjunction with FIG. 2,

FIG. 4 is a flow diagram showing another operation of the processor of the die machine of FIG. 1, and

FIG. 5 is a time versus temperature graph illustrating temperature of a die section when controlled in the manner described in conjunction with FIG. 4.

### DETAILED DESCRIPTION

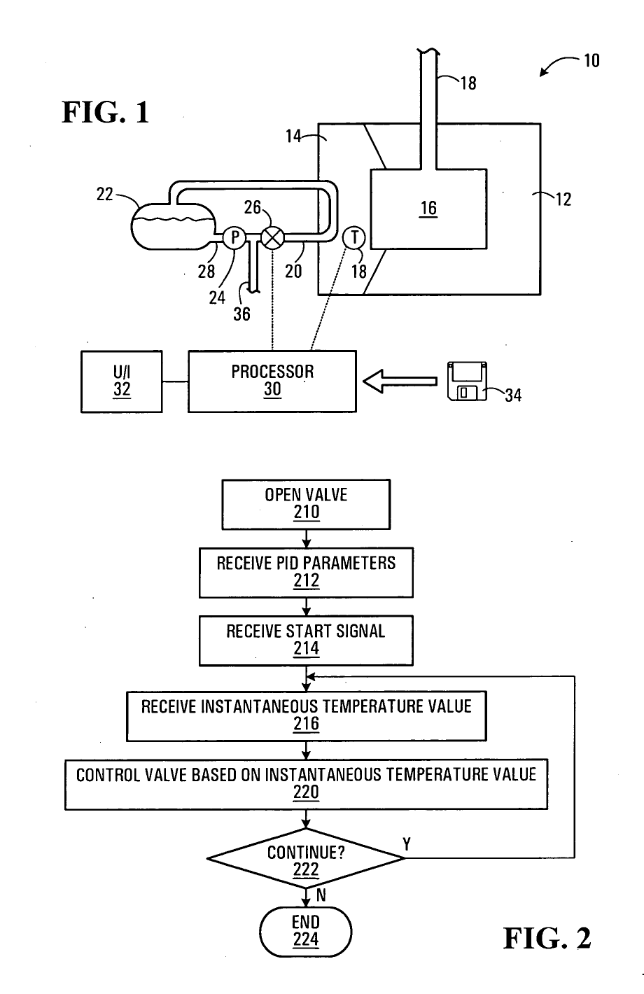

Turning to FIG. 1, a die casting machine 10 has a stationary die section 12 and a moveable die section 14. A die cavity 16 is formed when the moveable die section 14 is mated with the stationary section 12. Molten metal may be introduced to the die cavity through a runner 18.

A temperature sensor (e.g., a thermocouple) 18 is embedded in die section 14. A cooling line 20 runs through the die section 14. Cooling line 20 is a spur line extending from main cooling line 28. Coolant is pumped through the main cooling line 28 from a reservoir 22 by pump 24. A valve 26 in line 20, which may, for example, be a solenoid valve, controls the flow of fluid in spur line 20.

A processor 30 is operatively connected to the output of the temperature sensor 18 and to a control input of valve 26. A user interface 32 is operatively connected to the processor. The processor is configured for operation in accordance with this invention with computer readable instructions loaded from a computer readable medium 34 which may be, for example, a disc, memory chip, or a file downloaded from a remote source.

Although not shown, similarly to die section 14, die section 12 will also have an embedded temperature sensor outputting to processor 30 and a valved cooling spur line running through it (i.e., spur line 36) with the processor outputting to a control input of the valve of the spur line.

Many industrial feedback controllers use either proportional-integral (PI) or proportional-integral-derivative (PID) modes of feedback control. This suggests use of PID temperature control for die casting machine 10. FIG. 2 considers die section 14 when processor 30 is loaded with a PID control algorithm. Turning to FIG. 2, to prepare for operation of a die section having a temperature sensor and cooling valve, a user may input to the processor 30, via user interface 32, PID parameters: i.e., a set point, a proportional band, a reset time, and a rate time (212). As an initial condition, the processor maintains valve 26 open (210). On start-up, pump 24 may be activated and the die casting machine may be cycled through its operation to make die cast parts. As a result, the temperature of the die casting machine rises. The processor 30 receives a start signal on start-up (214) and instantaneous temperature values from sensor 18 (216).

The processor then controls the cooling valve utilising the instantaneous temperatures and the PID algorithm (220). More specifically, if the instantaneous temperature measured by the temperature sensor is above the top of the proportional temperature band, the valve in the cooling line for the die section is open so that coolant flows in the line to cool the die section. If the instantaneous temperature is below the bottom of the band, the valve is closed. And if the temperature is within the band, the valve is controlled dependent upon three different control strategies that are additively applied. More specifically, with proportional control, the valve is controlled based upon the controller gain (which is the inverse of the proportional band) and the difference between the instantaneous temperature and the set point (i.e., the “error”). Superimposed on this instantaneous proportional control is integral control which is provided to eliminate any offset, or steady-state error introduced by the proportional control. Also superimposed on the proportional control is derivative control, which acts when the error is changing with time. If the valve is a proportional valve, the valve control will establish the degree to which the valve is open. If the valve is an on/off valve, the control will establish the relative duration of on and off times. This continues until shut-down (222, 224).

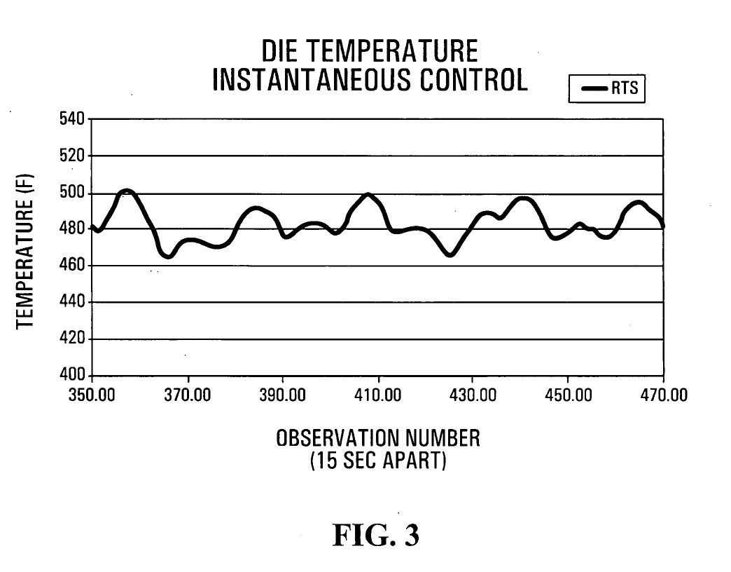

FIG. 3 illustrates the result of controlling a proportional valve of a particular die section of a die casting machine using a PID algorithm with a controller range of 750 degrees Fahrenheit, a set point temperature of 475 degrees Fahrenheit, a proportional band that is 3% of the range (i.e., a band that extends 11.25 degrees above and 11.25 degrees below the set point), a reset time of 1.5 minutes, and a rate time of 0.1 minutes. FIG. 3 is a time versus temperature graph illustrating the temperature of the die section over a period of time as the die casting machine cycles through its operation. For the die casting machine whose operation is illustrated in FIG. 3, the nominal cycle time of the die casting machine (i.e., the time to form one die casting and be ready to start the next die casting) was two minutes. As will be apparent from FIG. 3, the temperature of the die casting machine varies through about forty degrees Fahrenheit and the temperature fluctuations cycle unevenly: a smaller amplitude temperature cycle typically following a larger amplitude temperature cycle.

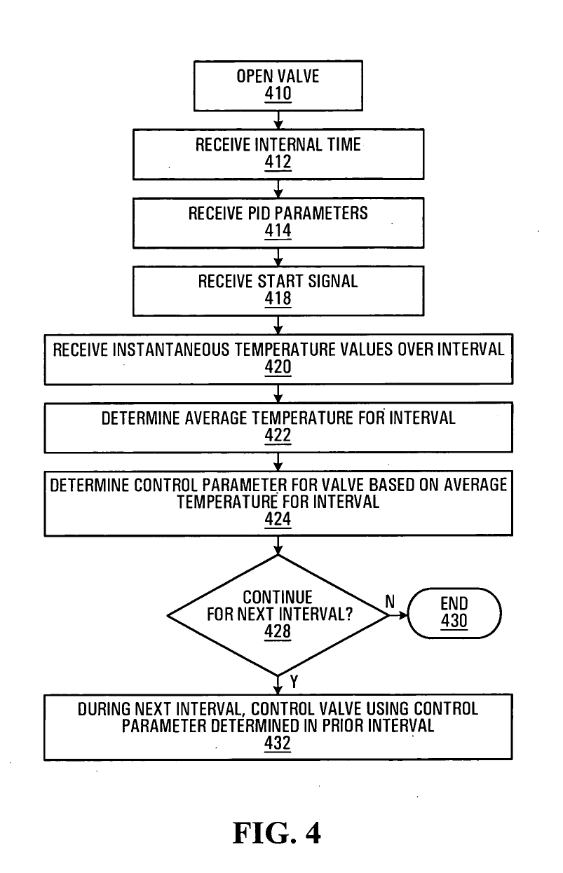

To improve performance, the valve control algorithm can be modified as follows. Referencing FIG. 4, to prepare for operation, a user may input to the processor 30, via user interface 32, an interval time (412) and PID parameters (414). As an initial condition, the processor maintains valve 26 open (410). On start-up, pump 24 may be activated and the die casting machine may be cycled through its operation to make die casting parts. As a result, the temperature of the die casting machine rises. The processor 30 receives a start signal on start-up (418) and instantaneous temperature values from sensor 18 (420).

The processor determines the average temperature for the first time interval (422). This may be accomplished by keeping a running average during the interval, or simply logging each instantaneous temperature value received and determining an average at the end of the interval. The processor then determines a control parameter for the valve based on this average temperature. More particularly, if the average temperature is above the proportional band, the control parameter will indicate a fully open valve. If the average temperature is below the proportional band, the control parameter will indicate a fully closed valve. If the average temperature is within the proportional band, three additive control strategies are again applied. With the proportional strategy, the determined average temperature is compared with the set point value to derive an error measure and the control gain is used to establish a degree to which the valve should be open in an interval (e.g., 50% open). Or, for an on/off valve, the control parameter may establish the relative time in an interval that the valve should be open. Assuming that the die casting machine is not shut down (428, 430), the valve 26 is controlled during the next interval based on the determined valve control parameter (432) (e.g., for a proportional valve, the control parameter might require the valve to remain 50% open for the duration of the next interval or for an on/off valve, the control parameter may require the valve to open at the beginning of the next interval and close once the determined proportion of an interval has elapsed). Also, during this next interval, the processor calculates a new average temperature (420, 422) and determines a new control parameter for the valve (424). This new valve control parameter is applied to control the valve during the next subsequent interval (432). This process repeats for as long as the die casting machine 10 continues producing castings.

From the foregoing, it will be apparent that during any given time interval, a valve control parameter is determined. However, this valve control parameter is not used to control the valve until the next subsequent time interval. This has the effect of reducing the magnitude of temperature fluctuations in the die section.

To reduce the frequency of re-configuring the valve, the time interval may be chosen as the nominal die cycle time. As the time for each die cycle may vary slightly from the nominal die cycle time, the time interval may be somewhat out of synchronism with any particular die cycle. However, it will be appreciated that since the temperature of the die section as the die cycles will approximate a sine wave, this possible lack of synchronism is of little significance. This can be seen by recognising that for a perfect sine wave, the area enclosed by the curve is the same over one period, no matter at what point the period is considered to have begun.

Instead of a user entering PID parameters via the user interface, PID parameters may be received from the processor as part of the software load from computer readable medium 34. In either case, it may be that these parameters are generalised parameters rather than being specific to die section 14. In such case, the processor will tune these parameters during operation in a manner understood to those skilled in the art.

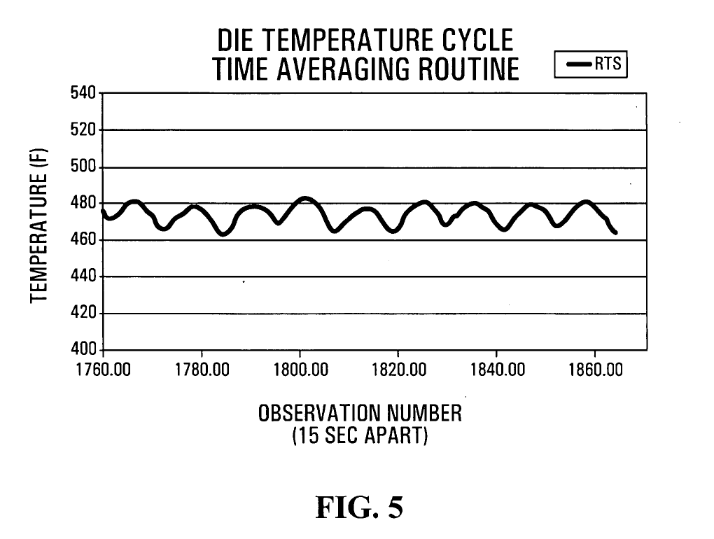

FIG. 5 is a time versus temperature graph illustrating the temperature of the same die section of the same die casting machine as that used to generate the graph of FIG. 3, as the die casting machine cycles through its operation. The interval time input was the nominal die casting cycle time of two minutes. All of the PID parameters input were the same as those used for the generation of the graph of FIG. 3. As will be apparent from FIG. 5, the temperature of the die casting machine varies through about twenty degrees Fahrenheit. Thus, by controlling a cooling line valve as described in conjunction with FIG. 4, tighter temperature control of a die cast section can be kept than by controlling the valve with reference to the instantaneous die section temperature. Furthermore, it will be noted that the temperature fluctuations cycle much more evenly than- do the temperature fluctuations illustrated in FIG. 3. This can result in improved quality die castings.

The described PID algorithm of FIG. 4 may be replaced with any other suitable algorithm for determining a valve control parameter based on the average temperature in an interval.

It would be possible for adjacent time intervals to be of different duration, but such a choice would likely worsen temperature control.

Other modifications will be apparent to those skilled in the art and, therefore, the invention is defined in the claims.

1. A method of die temperature control, comprising:
for a valved cooling line for a die area of a die:
receiving an indication of instantaneous temperature of said die area cooled by said valved cooling line;
determining an average temperature over a pre-determined first time interval from instantaneous temperature values for said first time interval;
based on said average temperature, determining a control parameter for a valve of said valved cooling line; and
controlling said valve during a second time interval next subsequent to said first time interval based on said control parameter.

2. The method of claim 1 wherein said valve may be controlled to be open or closed and wherein said determining a control parameter for said valve comprises determining a proportion of said second time interval during which said valve should be open.

3. The method of claim 1 wherein said first time interval and said second time interval are of identical duration.

4. The method of claim 3 wherein each of said first time interval and said second time interval have a duration equivalent to a nominal die cycle time.

5. The method of claim 1 wherein said determining a control parameter for said valve in a given temperature band is based on a difference between said average temperature and a set point temperature.

6. The method of claim 5 wherein said determining said control parameter for said valve in said given temperature band uses proportional, integral, and derivative modes of feedback control.

7. A computer readable medium containing computer executable instructions which, when executed on a processor input with instantaneous temperature for a die area of a die and having a control output for a control valve of a cooling line for said die area cause said processor to:
determine an average temperature over a pre-determined first time interval from instantaneous temperature values for said first time interval;
based on said average temperature, determine a control parameter for a valve of said valved cooling line; and
control said valve during a second time interval next subsequent to said first time interval based on said control parameter.

8. The computer readable medium of claim 6 wherein said valve may be controlled to be open or closed and wherein said computer executable instructions cause said processor to determine a control parameter for said valve by determining a proportion of said second time interval during which said valve should be open.

9. The computer readable medium of claim 6 wherein said first time interval and said second time interval are of identical duration.

10. The computer readable medium of claim 6 wherein each of said first time interval and said second time interval have a duration equivalent to a nominal die cycle time.

11. The computer readable medium of claim 6 wherein said computer executable instructions cause said processor to determine a control parameter for said valve in a given temperature band by determining a difference between said average temperature and a set point temperature.

12. The computer readable medium of claim 6 wherein said computer executable instructions cause said processor to determine a control parameter for said valve in said given temperature band by using proportional, integral, and derivative modes of feedback control.

13. A die casting machine, comprising:
at least one thermocouple for providing an indication of instantaneous temperature for a die area;
a cooling line for said die area having a valve;
a processor input by an output of said thermocouple and operatively associated with said valve for controlling said valve, said processor for:
determining an average temperature over a predetermined first time interval from instantaneous temperature values for said first time interval;
based on said average temperature, determining a control parameter for said valve; and
controlling said valve during a second time interval next subsequent to said first time interval based on said control parameter.
